(19) United States
(12) Patent Application Publication
(10) Pub. No.: US 2026/0359152 A1
(43) Pub. Date: Nov. 12, 2026

(54) SMART BMC

(71) Applicant: American Megatrends International, LLC, Duluth, GA (US)

(72) Inventors: Preethi Kalaiselvam, Johns Creek, GA (US); Manoj Kumar P, Panruti (IN); Balasubramanian Nagaiah, Round Rock, TX (US)

(21) Appl. No.: 19/199,891

(22) Filed: May 6, 2025

(51) Int. Cl. G06F 11/00; G06F 11/07; G06F 11/30; G06F 21/56

(52) U.S. Cl. CPC G06F 11/008; G06F 11/3058; G06F 21/567; G06F 11/0736; G06F 11/0793

(57) ABSTRACT

In an aspect of the disclosure, a method, a computer-readable medium, and an apparatus are provided. The apparatus may be a baseboard management controller (BMC). The BMC collects telemetry data from a plurality of components of a host computer. The BMC stores the telemetry data in a memory of the BMC. The BMC processes the telemetry data using a machine learning model executing within the BMC to predict a potential failure of at least one component of the plurality of components before the failure occurs. The BMC generates an alert based on the predicted potential failure.

### BACKGROUND

### Field

The present disclosure relates generally to computer systems, and more particularly, to techniques of implementing predictive analytics within a baseboard management controller (BMC) to proactively identify and mitigate potential hardware component failures before they occur.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Modern computing infrastructure relies heavily on data centers housing numerous computer systems or servers. Maintaining high availability and minimizing equipment downtime in these environments is paramount for business operations and service delivery. A significant contributor to server downtime is the degradation or failure of hardware components, such as memory modules, Peripheral Component Interconnect Express (PCIe) cards, cooling fans, and power supply units (PSUs). To manage and monitor server hardware, Baseboard Management Controllers (BMCs) are widely deployed. These specialized microcontrollers operate independently of the host server's main operating system and provide out-of-band management capabilities, allowing administrators remote access for monitoring, diagnostics, and control even if the host system is powered down or unresponsive.

Conventional BMCs perform essential monitoring functions by collecting data from various sensors embedded within the server chassis, tracking parameters like component temperatures, fan speeds, voltage levels, and error counters (e.g., memory correctable/uncorrectable errors). They typically log significant events and errors into a System Event Log (SEL) and utilize management protocols like the Intelligent Platform Management Interface (IPMI) or newer standards like Redfish to report status and alerts. However, this traditional approach is fundamentally reactive. Alerts regarding critical warnings or component failures are generally dispatched to a system administrator only after an issue has already occurred or reached a critical threshold, often necessitating immediate manual intervention by administrators or site engineers to diagnose the problem and perform corrective actions, leading to unavoidable server downtime and potential productivity losses.

While the concept of collecting telemetry data from server components is established, and predictive maintenance techniques using machine learning (ML) are applied in various domains, implementing effective proactive failure prediction directly within the resource-constrained environment of a typical BMC has remained a challenge. Existing approaches might involve offloading telemetry data to external, high-powered systems or cloud platforms for analysis. This introduces network dependencies, potential latency in receiving actionable insights, and data privacy concerns related to transmitting potentially sensitive operational logs outside the server boundary. Furthermore, conventional BMC systems typically lack the integrated capability to not only predict impending failures based on analyzing historical and real-time operational patterns locally but also to autonomously execute pre-approved mitigation or remediation actions to prevent the failure or minimize its impact without requiring immediate administrator confirmation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a baseboard management controller (BMC). The BMC collects telemetry data from a plurality of components of a host computer. The BMC stores the telemetry data in a memory of the BMC. The BMC processes the telemetry data using a machine learning model executing within the BMC to predict a potential failure of at least one component of the plurality of components before the failure occurs. The BMC generates an alert based on the predicted potential failure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller (BMC) and a host computer.

FIG. 2 is a diagram illustrating a system architecture for implementing a smart BMC with predictive analytics capabilities that utilizes machine learning.

FIG. 3 is a diagram illustrating a system architecture for deploying customized machine learning models within a BMC environment.

FIG. 4 is a flow chart of a method for operation of a BMC using predictive analytics.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

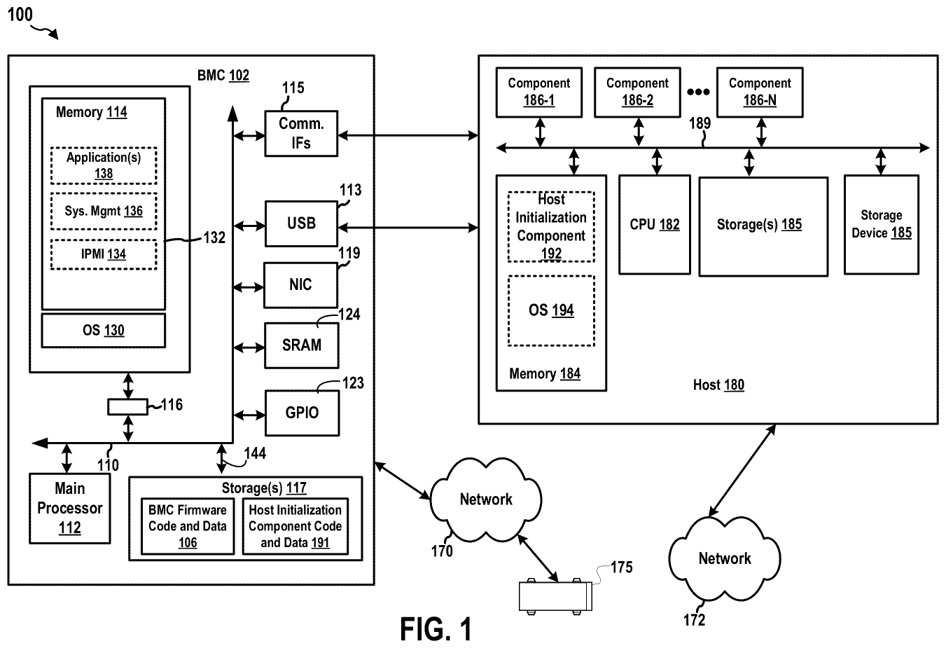

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

In data centers hosting numerous computer systems such as the computer system 100, equipment downtime presents a significant challenge, impacting productivity and incurring substantial costs. While power outages contribute to downtime, a frequent cause involves the degradation or failure of hardware components within servers, such as the host computer 180. Failures can occur in various component devices 186-1 to 186-N, including memory modules (like the host memory 184 or others), Peripheral Component Interconnect Express (PCIe) cards, cooling fans, or power supply units (PSUs). Conventionally, a baseboard management controller, such as the BMC 102, monitors these components using its system management component 136 and IPMI services 134. However, alerts regarding critical warnings or component failures are typically dispatched to a system administrator via the communication network 170 only after an incident has already occurred. This reactive approach limits the ability to prevent downtime.

There is a need to predict and prevent such hardware incidents proactively. A proactive system could significantly improve the productivity of server administrators. Furthermore, implementing automatic recovery or mitigation mechanisms within the server itself, managed by the BMC 102, can address detected issues promptly without requiring immediate intervention from a site engineer, thereby minimizing downtime and maintaining operational efficiency. Incorporating artificial intelligence (AI) or machine learning (ML) capabilities directly into the BMC 102 offers a path to achieve this proactive management. By analyzing historical operational data and component-specific telemetry, an ML model running within the BMC 102 can forecast server health and identify potential failures before they happen.

The proposed approach involves embedding an ML model within the BMC 102, for example within its service components 132, utilizing the main processor 112 and memory 114. This ML model is designed to observe error conditions and operational patterns within the host computer 180. The BMC 102 already possesses capabilities to monitor component devices 186, track errors, usage patterns, and diagnostics through interfaces like IPMI. This existing monitoring infrastructure provides the necessary input data for the ML model. For instance, by analyzing trends in fan speeds, component temperatures (CPU, GPU, PSU), memory error rates, or PCIe device statuses over time, the ML model can predict the remaining lifespan of components or identify precursors to failure. Based on these predictions, the BMC 102 can generate alerts and transmit them via its network interface card 119 to an administrator or a remote management system (such as the remote device 175).

In certain implementations, the BMC 102 may take autonomous corrective actions. While alerts can prompt administrator intervention, the system allows administrators to pre-approve certain mitigation actions. If a potential failure is predicted or an anomaly detected (e.g., related to security such as a DDoS attack pattern affecting communication), and pre-approval exists for the corresponding remedy, the BMC 102 can execute the action automatically without waiting for explicit administrator confirmation. This enhances the system's autonomy and responsiveness.

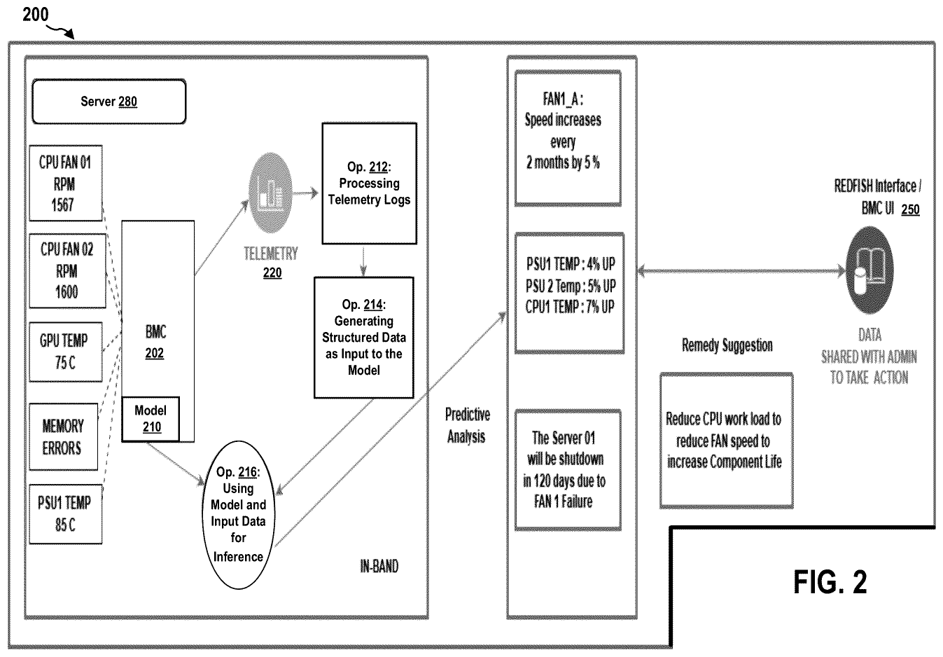

FIG. 2 is a diagram 200 illustrating a system architecture for implementing a smart BMC with predictive analytics capabilities. The diagram depicts the functional components and data flow within a server system that utilizes machine learning for proactive monitoring and management of server components.

In this example, a server 280 is equipped with a BMC 202 that monitors various hardware components. The BMC 202 continuously collects data from multiple sensors monitoring critical server components, including CPU fan speeds (showing CPU FAN 01 at 1567 RPM and CPU FAN 02 at 1600 RPM), GPU temperature (75 °C), memory error occurrences, and power supply unit temperature (PSU1 TEMP at 85 °C). This sensor data represents the raw telemetry information that the system analyzes to predict potential failures.

A data processing workflow within the BMC 202 may include three primary operations. In operation 212, the system processes telemetry logs collected from the various server components. These logs contain data about component performance, errors, and operational parameters. In operation 214, the system transforms the processed telemetry logs into structured data suitable for analysis by a machine learning model 210. The structured data serves as input to the model 210. In operation 216, the system uses the model 210 and the structured input data to perform inference operations, generating predictive insights about component health and potential failures.

The machine learning model 210 resides entirely within the BMC 202. Rather than sending telemetry data to external systems for analysis, the model 210 operates “in-band”—directly within the BMC's processing environment. This approach eliminates dependency on external systems and network connectivity for predictive maintenance while maintaining data privacy by keeping sensitive telemetry information local.

Further, in this example, outputs of the predictive analysis process and the interfaces through which these insights are communicated. The system identifies patterns in component behavior that may indicate future failures. For example, it has detected that “FAN1_A” speed increases by 5% every two months, PSU 1 temperature has increased by 4%, PSU 2 temperature has increased by 5%, and CPU1 temperature has increased by 7%. Based on these patterns, the system predicts that “The Server 01 will be shutdown in 120 days due to FAN 1 Failure.” This prediction provides administrators with a specific timeframe for preventive maintenance.

The system also generates remediation suggestions based on its analysis. In this example, it recommends to “Reduce CPU work load to reduce FAN speed to increase Component Life.” These actionable recommendations help administrators take targeted preventive measures rather than waiting for components to fail.

The predictive insights and remediation suggestions are communicated through a REDFISH Interface/BMC UI 250. The REDFISH interface is a standardized API for server management that allows the BMC to share data with administrative systems and interfaces. In this example, the data is “SHARED WITH ADMIN TO TAKE ACTION.”

In some implementations, the BMC 202 can be configured to take certain remedial actions automatically, subject to pre-approval from administrators. This capability is particularly valuable in situations where immediate action is required but administrator access might be compromised or unavailable, such as during a DDoS attack that disrupts network connectivity.

The machine learning model 210 utilized in this system is specifically designed to operate within the resource constraints of a BMC environment. While complex neural networks might require substantial computing resources, the model 210 focuses on statistical analysis of component data, making it sufficiently lightweight to run on the BMC's main processor 112 and within its memory 114 constraints (as referenced in FIG. 1). The model 210 may implement relatively simple algorithms such as regression models or decision trees that can effectively identify patterns in telemetry data without requiring extensive computational resources.

The model 210 is pre-trained using historical data collected from data centers with similar server configurations. The training process may occur externally on more powerful systems, after which the optimized and minimized model is deployed to the BMC 202. Only the inference operations, which require significantly less computational power than training, occur within the BMC 202 itself.

As described supra, the BMC 202, analogous to the BMC 102 in FIG. 1, actively collects telemetry data from various sensors monitoring the host computer's components (corresponding to component devices 186-1 to 186-N in FIG. 1). The telemetry data may include CPU fan speeds, GPU temperature, memory error logs, and PSU temperatures. This collected data, potentially stored locally within the BMC's storage 117 (FIG. 1) perhaps as structured files like .csv files in designated directories (e.g., ‘/var’), serves as the foundation for the predictive analysis.

The machine learning model 210 may be executed by the BMC's main processor 112 using its memory 114 (FIG. 1). This model 210 is specifically developed and optimized to operate within the resource constraints of the BMC 202. The training of the model 210 typically occurs offline, potentially in a cloud environment or on high-performance computing systems, using historical data gathered from numerous servers in data center environments. This training process develops the model's ability to recognize patterns indicative of potential future failures based on factors like component behavior trends (e.g., gradual fan speed increases, temperature anomalies) and error logs. Once trained, an optimized, potentially minimized version of the model 210 is deployed onto the BMC 202. In some implementations, the model may be modular, allowing administrators to select and deploy specific monitoring capabilities (e.g., focusing only on thermal components, or security events) to further minimize the resource footprint within the BMC 202.

Within the BMC 202, a periodic analysis workflow is executed. This involves processing the collected telemetry logs (operation 212), transforming this data into a structured format suitable for the model 210 (operation 214), and performing inference using the deployed model 210 (operation 216). This inference step, running entirely “in-band” within the BMC 202, generates predictive insights without transmitting sensitive telemetry data externally. The model 210 analyzes the current operational data in light of the patterns learned during training. For instance, as depicted, the analysis might identify a consistent 5% increase in FAN1_A's speed every two months, alongside rising temperatures in PSUs and a CPU.

Based on this analysis, the model 210 generates predictive insights, such as identifying the affected component (FAN 1), estimating the time until failure (e.g., 120 days), assessing potential impacts on other components (e.g., related temperature increases), and suggesting mitigation actions. In the example shown, the system predicts a server shutdown due to the impending FAN 1 failure and suggests reducing the CPU workload as a remedial measure to lower fan speed and potentially extend the component's life.

These predictive insights and remediation suggestions are then communicated to a system administrator, for example, via the REDFISH interface or a BMC user interface (UI) 250. This allows the administrator (potentially using a remote device 175 connected via the communication network 170, as shown in FIG. 1) to be notified proactively about potential issues. Remediation actions, such as the suggested workload reduction, can then be performed based on the administrator's approval received through the interface 250. Furthermore, the system can be configured to allow administrators to pre-approve certain automated actions. In such cases, upon detecting a specific predicted failure or anomaly for which pre-approval exists, the BMC 202 can autonomously execute the corresponding mitigation strategy, thereby providing rapid response even without immediate administrator intervention. This local processing and potential for autonomous action enhance data privacy and system resilience.

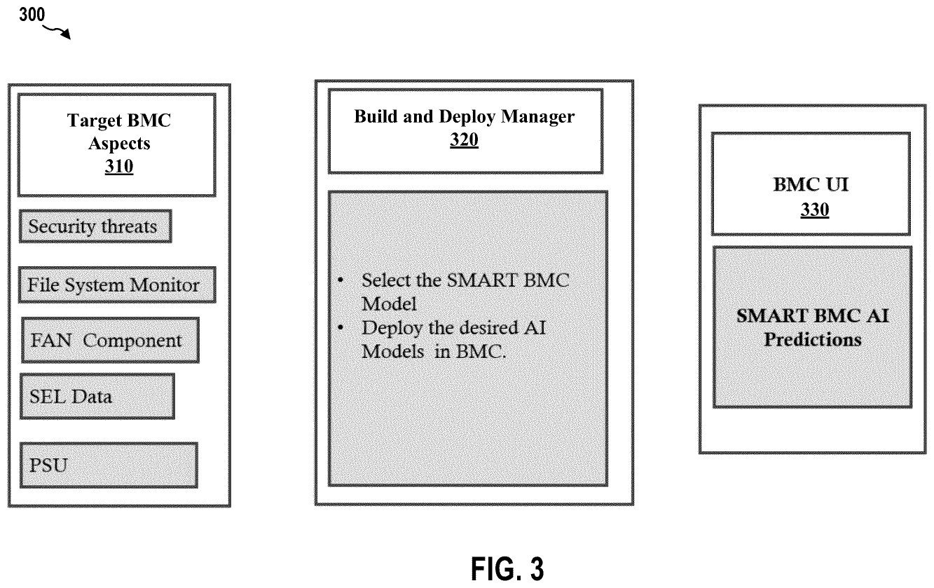

FIG. 3 is a diagram 300 illustrating a system architecture for deploying customized machine learning models within a BMC environment. The architecture provides a modular approach to model selection, deployment, and utilization, allowing administrators to target specific aspects of server management for predictive analytics.

The system architecture 300 comprises three primary components: Target BMC Aspects 310, Build and Deploy Manager 320, and BMC UI 330. This architecture enables the implementation of the SMART BMC concept through a component-based approach that addresses the resource constraints of BMC environments while maximizing the effectiveness of machine learning applications for server management.

The Target BMC Aspects 310 component represents a collection of server management domains that can be monitored and analyzed using machine learning models. These domains include security threats, which might involve detecting patterns indicative of potential security breaches or unauthorized access attempts. A File System Monitor aspect focuses on tracking file system operations and detecting anomalies that might indicate corruption or impending storage failures. The FAN Component aspect specifically monitors cooling systems, tracking metrics such as RPM variations, vibration patterns, and acoustic signatures that might precede fan failures. SEL Data refers to System Event Log data, which contains records of system events and errors that can be analyzed for patterns indicating potential issues. Finally, the PSU (Power Supply Unit) aspect monitors power-related metrics such as voltage stability, current draw, and temperature fluctuations.

The Build and Deploy Manager 320 serves as the orchestration component for model selection and deployment. This component allows administrators to “Select the SMART BMC Model” appropriate for their specific monitoring needs. Rather than deploying a single, monolithic machine learning model that attempts to address all server management aspects, administrators can choose from specialized micro-models tailored to specific aspects listed in the Target BMC Aspects 310. This selective approach helps minimize the resource footprint within the resource-constrained BMC environment. The Build and Deploy Manager 320 also handles the process to “Deploy the desired AI Models in BMC,” managing the transfer and installation of the selected models onto the BMC's storage and memory systems.

The BMC UI 330 provides the interface through which administrators interact with the deployed models and view the analytical results. Below the BMC UI 330 is the SMART BMC AI Predictions component, which represents the output of the deployed machine learning models. This component generates actionable insights based on the model inferences, such as component failure predictions, anomaly detections, and recommended remediation actions.

The workflow within this architecture begins with an administrator selecting specific aspects of server management they wish to monitor through predictive analytics. For example, an administrator primarily concerned with cooling system reliability might select only the FAN Component aspect from the Target BMC Aspects 310. The Build and Deploy Manager 320 then identifies the appropriate micro-models associated with the selected aspects. These micro-models have been pre-trained in a more resource-rich environment, such as a cloud platform as described in the Background Information, using historical data from similar server configurations.

The Build and Deploy Manager 320 optimizes these models for the specific BMC environment, potentially applying techniques such as quantization to reduce model size while maintaining acceptable accuracy. The optimized models are then deployed to the BMC, where they operate within the BMC's processing environment, analyzing real-time telemetry data collected from the corresponding server components. The resulting predictions and insights are then made available through the BMC UI 330, allowing administrators to take proactive measures before issues escalate to critical failures.

This modular architecture addresses several key challenges in implementing machine learning capabilities within BMC environments. The ability to select specific management aspects helps overcome the memory and processing limitations of BMCs by deploying only the necessary models rather than a comprehensive but resource-intensive solution. The Build and Deploy Manager 320 facilitates the transition from model training in resource-rich environments to inference in resource-constrained environments. Through the BMC UI 330, the insights generated by the deployed models are accessible and actionable for administrators.

The architecture shown in FIG. 3 represents an improvement over traditional BMC operations where alerts are typically generated only after failures or critical issues have already occurred. By implementing targeted predictive analytics through specialized micro-models, the SMART BMC can identify potential issues before they manifest as failures, allowing for proactive intervention and significantly reducing server downtime. This approach can extend component lifecycles, reduce maintenance costs, and improve overall data center operational efficiency.

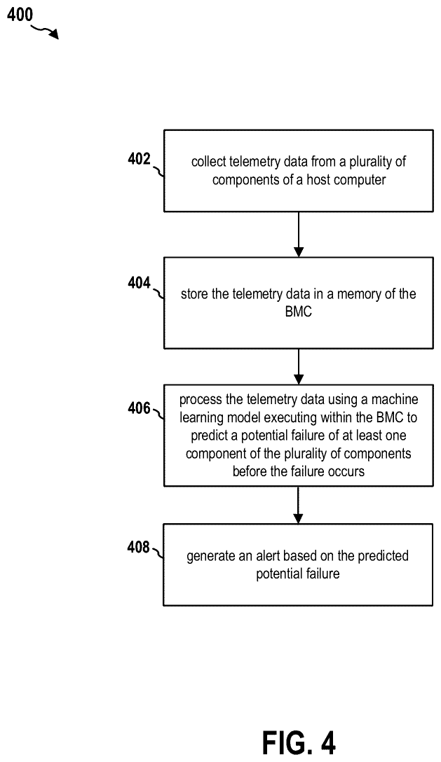

FIG. 4 is a flow chart 400 of a method (process) for operation of a BMC using predictive analytics. The method may be performed by a BMC (e.g., the BMC 102 or BMC 202).

In operation 402, the BMC collects telemetry data from a plurality of components of a host computer. In certain configurations, the telemetry data comprises at least one of: fan speed data; temperature data for central processing units (CPUs), graphics processing units (GPUs), or power supply units (PSUs); memory error rates; and peripheral component interconnect express (PCIe) device status data.

In operation 404, the BMC stores the telemetry data in a memory of the BMC. In operation 406, the BMC processes the telemetry data using a machine learning model executing within the BMC to predict a potential failure of at least one component of the plurality of components before the failure occurs. In certain configurations, the telemetry data is processed entirely within the BMC without transmitting the telemetry data to external systems. In certain configurations, the machine learning model is pre-trained using historical telemetry data from a plurality of servers and deployed to the BMC for inference operations. To process the telemetry data, the BMC transforms the telemetry data into a structured format compatible with the machine learning model, and performs inference using the machine learning model to identify patterns indicative of the potential failure. In certain configurations, the machine learning model analyzes trends in the telemetry data over time to identify gradual changes in component performance that precede component failure. In certain configurations, the machine learning model comprises at least one of a regression model and a decision tree model optimized to operate within resource constraints of the BMC. In certain configurations, the BMC detects a security-related anomaly through analysis of the telemetry data.

In operation 408, the BMC generates an alert based on the predicted potential failure. In certain configurations, the alert includes at least one of: an identification of the component predicted to fail; an estimated time until failure; potential impacts on other components; and suggested mitigation actions. In certain configurations, the alert is communicated to an administrator via a Redfish interface.

In certain configurations, the BMC determines a remediation action to address the predicted potential failure and includes the remediation action in the alert. In certain configurations, subsequent to determining the remediation action, the BMC receives an approval from an administrator to perform the remediation action, and executes the remediation action in response to receiving the approval. In certain configurations, subsequent to determining the remediation action, the BMC determines whether the remediation action has been pre-approved by an administrator. The BMC automatically executes the remediation action when the remediation action has been pre-approved. The BMC awaits explicit approval before executing the remediation action when the remediation action has not been pre-approved. In certain configurations where a security-related anomaly is detected, the BMC automatically implements security countermeasures when communication with an administrator is compromised.

In certain configurations, the BMC provides a user interface that enables an administrator to select specific aspects of the host computer to monitor using the machine learning model. The specific aspects include at least one of: security threats; file system operations; fan components; system event log data; and power supply units. In such configurations, the BMC deploys a specific machine learning micro-model to the BMC based on the selected specific aspects. The specific machine learning micro-model is optimized for the selected specific aspects.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of operation of a baseboard management controller (BMC) that is embedded on a motherboard of a host computer and operates independently of an operating system of the host computer, comprising:
collecting telemetry data from a plurality of components of the host computer;
storing the telemetry data in a memory of the BMC;
processing the telemetry data using a machine learning model executing within the BMC to predict a potential failure of at least one component of the plurality of components before the failure occurs, wherein the machine learning model is a size-reduced version of a trained machine learning model that has been trained on a computing system external to the BMC, the size-reduced version being optimized to execute within processing resources and memory resources of the BMC, and wherein the BMC performs inference operations of the machine learning model without performing training of the machine learning model; and
generating an alert based on the predicted potential failure.

2. The method of claim 1, wherein the machine learning model is pre-trained using historical telemetry data from a plurality of servers and deployed to the BMC for inference operations.

3. The method of claim 1, wherein processing the telemetry data comprises:
transforming the telemetry data into a structured format compatible with the machine learning model; and
performing inference using the machine learning model to identify patterns indicative of the potential failure.

4. The method of claim 1, further comprising:
determining a remediation action to address the predicted potential failure; and
including the remediation action in the alert.

5. The method of claim 4, further comprising:
receiving an approval from an administrator to perform the remediation action; and
executing the remediation action in response to receiving the approval.

6. The method of claim 4, further comprising:
determining whether the remediation action has been pre-approved by an administrator;
automatically executing the remediation action when the remediation action has been pre-approved; and
awaiting explicit approval before executing the remediation action when the remediation action has not been pre-approved.

7. The method of claim 1, wherein the alert includes at least one of:
an identification of the component predicted to fail;
an estimated time until failure;
potential impacts on other components; and
suggested mitigation actions.

8. The method of claim 1, wherein the telemetry data comprises at least one of:
fan speed data;
temperature data for central processing units (CPUs), graphics processing units (GPUs), or power supply units (PSUs);
memory error rates; and
peripheral component interconnect express (PCIe) device status data.

9. The method of claim 1, wherein the machine learning model comprises at least one of a regression model and a decision tree model, the regression model and the decision tree model each optimized to operate within resource constraints of the BMC.

10. The method of claim 1, further comprising:
providing a user interface that enables an administrator to select specific aspects of the host computer to monitor using the machine learning model, wherein the specific aspects include at least one of:
security threats;
file system operations;
fan components;
system event log data; and
power supply units.

11. A method of operation of a baseboard management controller (BMC) that is embedded on a motherboard of a host computer and operates independently of an operating system of the host computer, comprising:
collecting telemetry data from a plurality of components of the host computer;
storing the telemetry data in a memory of the BMC;
providing a user interface that enables an administrator to select specific aspects of the host computer to monitor using a machine learning model, wherein the specific aspects include at least one of: security threats; file system operations; fan components; system event log data; and power supply units;
deploying a specific machine learning micro-model to the BMC as the machine learning model based on the selected specific aspects, wherein the specific machine learning micro-model is optimized for the selected specific aspects and is optimized to execute within processing resources and memory resources of the BMC;
processing the telemetry data using the machine learning model executing within the BMC to predict a potential failure of at least one component of the plurality of components before the failure occurs; and
generating an alert based on the predicted potential failure.

12. The method of claim 1, wherein the machine learning model analyzes trends in the telemetry data over time to identify gradual changes in component performance that precede component failure.

13. The method of claim 1, wherein the alert is communicated to an administrator via a Redfish interface.

14. The method of claim 1, further comprising:
detecting a security-related anomaly through analysis of the telemetry data; and
automatically implementing security countermeasures when communication with an administrator is compromised.

15. A method of operation of a baseboard management controller (BMC) that is embedded on a motherboard of a host computer and operates independently of an operating system of the host computer, comprising:
collecting telemetry data from a plurality of components of the host computer;
storing the telemetry data in a memory of the BMC;
processing the telemetry data using a machine learning model executing within the BMC to predict a potential failure of at least one component of the plurality of components before the failure occurs, wherein the machine learning model is optimized to execute within processing resources and memory resources of the BMC, and wherein the telemetry data is processed entirely within the BMC without transmitting the telemetry data to external systems, thereby enhancing data privacy and security; and
generating an alert based on the predicted potential failure.

16. A baseboard management controller (BMC) that is embedded on a motherboard of a host computer and operates independently of an operating system of the host computer, the BMC including one or more computing devices, comprising:
a memory; and
at least one processor coupled to the memory and configured to:
collect telemetry data from a plurality of components of a the host computer;
store the telemetry data in the memory;
process the telemetry data using a machine learning model executing within the BMC to predict a potential failure of at least one component of the plurality of components before the failure occurs, wherein the machine learning model is a size-reduced version of a trained machine learning model that has been trained on a computing system external to the BMC, the size-reduced version being optimized to execute within the at least one processor and the memory of the BMC, and wherein the at least one processor performs inference operations of the machine learning model without performing training of the machine learning model; and
generate an alert based on the predicted potential failure.

17. The BMC of claim 16, wherein the machine learning model is pre-trained using historical telemetry data from a plurality of servers and deployed to the BMC for inference operations.

18. The BMC of claim 16, wherein to process the telemetry data, the at least one processor is configured to:
transform the telemetry data into a structured format compatible with the machine learning model; and
perform inference using the machine learning model to identify patterns indicative of the potential failure.

19. The BMC of claim 16, wherein the at least one processor is further configured to:
determine a remediation action to address the predicted potential failure; and
include the remediation action in the alert.

20. A non-transitory computer-readable medium storing computer executable code for operating a baseboard management controller (BMC) that is embedded on a motherboard of a host computer and operates independently of an operating system of the host computer, comprising code to:
collect telemetry data from a plurality of components of a the host computer;
store the telemetry data in a memory of the BMC;
process the telemetry data using a machine learning model executing within the BMC to predict a potential failure of at least one component of the plurality of components before the failure occurs, wherein the machine learning model is a size-reduced version of a trained machine learning model that has been trained on a computing system external to the BMC, the size-reduced version being optimized to execute within processing resources and memory resources of the BMC, and wherein the BMC performs inference operations of the machine learning model without performing training of the machine learning model; and
generate an alert based on the predicted potential failure.
